(19) United States
(12) Patent Application Publication
(10) Pub. No.: US 2022/0147929 A1
(43) Pub. Date: May 12, 2022

(54) SYSTEMS, METHODS AND DEVICES FOR DISTRIBUTING VARIOUS PRODUCTS

(71) Applicant: FABRICATION LLENAR INC., ROUGEMONT (CA)

(72) Inventors: Robert BESSETTE, Saint-Jean-sur-Richelieu (CA); Jean-Sébastien DESCHAMBAULT, Granby (CA); Jacinthe BROUILLARD, Rougemont (CA)

(73) Assignee: FABRICATION LLENAR INC., ROUGEMONT, QC (CA)

(21) Appl. No.: 17/609,782

(22) PCT Filed: May 8, 2020
(86) PCT No.: PCT/CA2020/050629

§ 371 Date: Nov. 9, 2021

Related U.S. Application Data
(60) Provisional application No. 62/845,461, filed on May 9, 2019.

(51) Int. Cl. G06Q 10/08; B65B 43/59; B65B 57/00; B65B 3/04; B65B 1/04; B67D 7/02; B67D 7/08; A47F 3/00

(52) U.S. Cl. CPC G06Q 10/0875; G06Q 10/0835; B65B 43/59; B65B 57/00; A47F 3/005; B65B 1/04; B67D 7/02; B67D 7/08; B65B 3/04

(57) ABSTRACT

Systems and methods for distributing one or more products are described herein. The systems include at least one communication network; a distribution server and a device for refilling a container with the one or more products. The device includes a supply tank configured to retain the one or more products; a sensor configured to detect a level of the one or more products in the supply tank; a device communication interface operable to communicate with the distribution server; and a device processing unit. The device processing unit is operable to: receive a signal from the sensor indicating the level of the one or more products, determine whether the level is below a minimum threshold level; when the level is below the minimum threshold level, generate a request for a distributor to distribute more of the one or more products to the device; and communicate the request to the distribution server.

### CROSS-REFERENCE TO RELATED APPLICATIONS

This application claims priority to U.S. Provisional Patent Application No. 62/845,461 that was filed on 9 May 2019, the contents of which are incorporated herein by reference for all purposes.

### TECHNICAL FIELD

The embodiments disclosed herein relate to systems, methods and devices, and more specifically, to systems, methods and devices for distributing various products.

### BACKGROUND

Many consumer products are sold in packages such as bottles, bags and boxes that are discarded after the consumer product has been used. Commonly these packages are manufactured from plastics that are difficult to recycle. Accordingly, households generate substantial waste in the form of product packaging.

Additional waste is also created when packages of consumer products are placed in cartons or crates to be shipped or distributed from a place of manufacture to point of purchase establishments.

In an effort to minimize packaging waste, reusable and refillable containers have been developed for consumer products, particularly consumer products that can be offered in bulk. However, the use of refillable containers for consumer products is currently limited to products that can be easily inserted into and removed from the packaging.

Further, it can be difficult to monitor the inventory of consumer goods that are sold in bulk or in refillable containers.

Accordingly, there is a need for systems, methods and devices for distributing various products between a manufacture and a point of purchase. There is also a need for systems, methods and devices for refilling containers.

### SUMMARY

Systems, devices and methods for distributing various products are described herein

According to one broad aspect, a system for distributing one or more products is described herein. The system includes at least one communication network; a distribution server comprising: a distribution server communication interface; and a distribution server processing unit operable to communicate with the distribution server communication interface; and a device for refilling a container with the one or more products, the device comprising: a supply tank configured to retain the one or more products; a sensor configured to detect a level of the one or more products in the supply tank; a device communication interface operable to communicate with the distribution server via the communication network; and a device processing unit operable to communicate with the sensor, the device processing unit operable to: receive a signal from the sensor, the signal indicating the level of the one or more products in the supply tank; determine whether the level of the one or more products in the supply tank is below a minimum threshold level; when the level of the one or more products in the supply tank is below the minimum threshold level, generate a request for a distributor to distribute more of the one or more products to the device; and communicate the request for the distributor to distribute more of the one or more products to the device to the distribution server via the communication network.

According to another broad aspect, a method of distributing one or more products is described herein. The method includes receiving a signal at a device processing unit of a device for refilling a container with one or more products from a sensor of the device, the signal indicating the level of the one or more products in a supply tank of the device; determining whether the level of the one or more products in the supply tank is below a minimum threshold level; when the level of the one or more products in the supply tank is below the minimum threshold level, generating a request for a distributor to distribute more of the one or more products to the device; and communicating the request for the distributor to distribute more of the one or more products to the device to a distribution server via a communication network.

According to another broad aspect, a device for refilling a container with the one or more products is described herein. the device includes a supply tank configured to retain the one or more products; a sensor configured to detect a level of the one or more products in the supply tank; a device communication interface operable to communicate with a distribution server via a communication network; and a device processing unit operable to communicate with the sensor, the device processing unit operable to: receive a signal from the sensor, the signal indicating the level of the one or more products in the supply tank; determine whether the level of the one or more products in the supply tank is below a minimum threshold level; when the level of the one or more products in the supply tank is below the minimum threshold level, generate a request for a distributor to distribute more of the one or more products to the device; and communicate the request for the distributor to distribute more of the one or more products to the device to the distribution server via the communication network.

According to another broad aspect, a device for refilling a container with one or more products is described herein. The device includes a supply tank configured to retain the one or more products; a dispensing head fluidly coupled to the supply tank, the dispensing head configured to receive the one or more products from the supply tank and provide the one or more products to the container; a housing configured to receive the container and support the container in a position to receive the one or more products from the dispensing head; a scanner configured to scan the container; a processor coupled to the supply tank, the dispensing head and the scanner, the processor operable to: direct the scanner to scan at least a portion of the container; receive the scan of the at least a portion of the container; determine a type of the container and/or a volume of the one or more products to provide to the container based on the scan of the container; and direct the supply tank and the dispensing head to provide the one or more products to the container.

According to another broad aspect, a method of refilling a container with one or more products is described herein. The method includes directing a scanner of a device for refilling the container with the one or more products to scan at least a portion of the container; receiving the scan of the at least a portion of the container; determining a type of the container and/or a volume of the one or more products to provide to the container based on the scan of the container; and directing a supply tank and a dispensing head of the device for refilling the container to provide the one or more products to the container.

According to another broad aspect, a method of refilling a container with one or more products is described herein. The method includes receiving a selected container type to receive a product to be dispensed into the container; directing an imaging device to capture an image of at least a portion of the container when the container is placed within a cavity of a device for refilling the container with the product; receiving the image of the at least a portion of the container; determining if the container is at a correct position within the cavity based on the selected container type; and directing a dispensing head of the device to dispense the selected product into the container.

These and other features and advantages of the present application will become apparent from the following detailed description taken together with the accompanying drawings. However, it should be understood that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a perspective view of a device for refilling a container, according to one embodiment;

FIG. 2 shows a exploded perspective view of several components of the device for refilling a container of FIG. 1;

FIG. 3 shows a perspective view of a system for refilling the device for refilling a container of FIG. 1;

FIG. 4 shows a perspective view of a positioner plate of the device of FIG. 7 1, according to one embodiment;

FIG. 5 is a perspective view of a filling cart for filling supply tanks of the device of FIG. 1 with the one or more products, according to one embodiment;

FIG. 6 is a schematic diagram of a system for distributing one or more products, according to one embodiment; and

FIG. 7 is a block diagram of a method of dispensing a product into a container, according to one embodiment.

The skilled person in the art will understand that the drawings, further described below, are for illustration purposes only. The drawings are not intended to limit the scope of the applicant's teachings in any way. Also, it will be appreciated that for simplicity and clarity of illustration, elements shown in the figures have not necessarily been drawn to scale. For example, the dimensions of some of the elements may be exaggerated relative to other elements for clarity. Further aspects and features of the example embodiments described herein will appear from the following description taken together with the accompanying drawings.

### DETAILED DESCRIPTION

Various systems and methods are described below to provide an example of at least one embodiment of the claimed subject matter. No embodiment described below limits any claimed subject matter and any claimed subject matter may cover systems and methods that differ from those described below. The claimed subject matter are not limited to systems and methods having all of the features of any one system and method described below or to features common to multiple or all of the systems and methods described below. Subject matter that may be claimed may reside in any combination or sub-combination of the elements or process steps disclosed in any part of this document including its claims and figures. Accordingly, it will be appreciated by a person skilled in the art that a system or method disclosed in accordance with the teachings herein may embody any one or more of the features contained herein and that the features may be used in any particular combination or sub-combination that is physically feasible and realizable for its intended purpose.

Furthermore, it is possible that a system or method described below is not an embodiment of any claimed subject matter. Any subject matter that is disclosed in a system or method described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

It will also be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the result is not significantly changed. These terms of degree should be construed as including a deviation of the modified term, such as 1%, 2%, 5%, or 10%, for example, if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should be noted that the term “coupled” used herein indicates that two elements can be directly coupled to one another or coupled to one another through one or more intermediate elements.

It should also be noted that, as used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein.

Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Systems, devices and methods for distributing various products are described herein. The systems, devices and methods described herein may be used in grocery stores and/or other consumer product points of sale (e.g. department stores, drug stores, general purpose stores and the like) for distributing bulk products. Herein the term “bulk products” may refer to goods or cargo that is not sold in packages or boxes. For example, “bulk products” may refer to solid bulk products or liquid bulk products, such as but not limited to cleaning agents. For example, the cleaning agents can be soaps (e.g. hand soap, laundry detergent, all-purpose soap, shampoo, conditioner, dishwasher soap, body wash or the like), floor cleaning preparations, skin cleansing preparations, window washing fluids, etc. For example, the bulk products can be food products such as confectionaries (e.g. candies, chocolate, sugars and the like), cereals, flours, nuts, fruits, dried fruits, etc.

As noted above, many consumer products are sold in packages such as bottles, bags and boxes that are typically made of plastic. As such, households typically generate excessive waste in the form of product packaging. In an effort to reduce consumer waste in the form of product packaging, the devices described herein are intended to be used to refill containers with one or more bulk products. The devices include supply tanks and dispensing heads that can be used to refill containers with one or more products in an efficient manner.

However, additional waste can be generated when consumer product packages are transported in cartons or crates (i.e. secondary packaging) that must be shipped to point of purchase establishments and subsequently discarded.

To help reduce this secondary packaging, the devices described herein may include one or more sensors that monitor supply levels of the one or more products in the device and automatically generate and transmit requests for distribution of the one or more products from the manufacturer when the supply levels in the device reaches a pre-selected minimum threshold. This may optimize transportation logistics (e.g. minimize fuel costs, reduce pollution, reduce energy consumption) of distributing the one or more products from the point of manufacture to the point of purchase.

According to some embodiments, the sensor is positioned within the supply tank.

According to some embodiments, the sensor is positioned adjacent to the supply tank.

According to some embodiments, the device comprises a housing and a dispensing head to dispense the one or more products into the container, the housing comprising a positioner plate configured to support the container in a position to receive the one or more products from the dispensing head.

According to some embodiments, a top surface of the positioner plate includes contours to conform to a bottom portion of at least one container.

According to some embodiments, the housing further comprises a container elevator to raise and/or lower the container within the housing relative to the dispensing head.

According to some embodiments, the housing includes an opening and an interior volume extending inwardly from the opening, the interior volume being sized to contain the container while the container is being refilled.

According to some embodiments, the housing further comprises a door configured to cover the opening.

According to some embodiments, the device includes a gate sensor communicatively coupled to the supply tank and configured to detect when the door does not cover the opening, the gate sensor configured to generate a signal that inhibits transfer of the one or more products from the supply tank to the dispensing head when the door does not cover the opening.

According to some embodiments, the device for refilling the container includes an imaging device.

According to some embodiments, the imaging device is a three-dimensional camera positioned inside of the interior volume of the housing.

According to some embodiments, the dispensing head is configured to receive more than one product form the supply tank and provide the more than one product to the container.

According to some embodiments, the dispensing head is configured to receive four products form the supply tank and provide the four products to the container.

According to some embodiments, the dispensing head is positioned above the positioner plate and is rotatable about a vertical axis extending through the positioner plate.

According to some embodiments, the one or more products are bulk products.

According to some embodiments, the one or more products are liquid bulk products.

According to some embodiments, the one or more products are solid bulk products.

According to some embodiments, the one or more products include a soap such as a liquid laundry detergent, hand soap, shampoo or all-purpose soap.

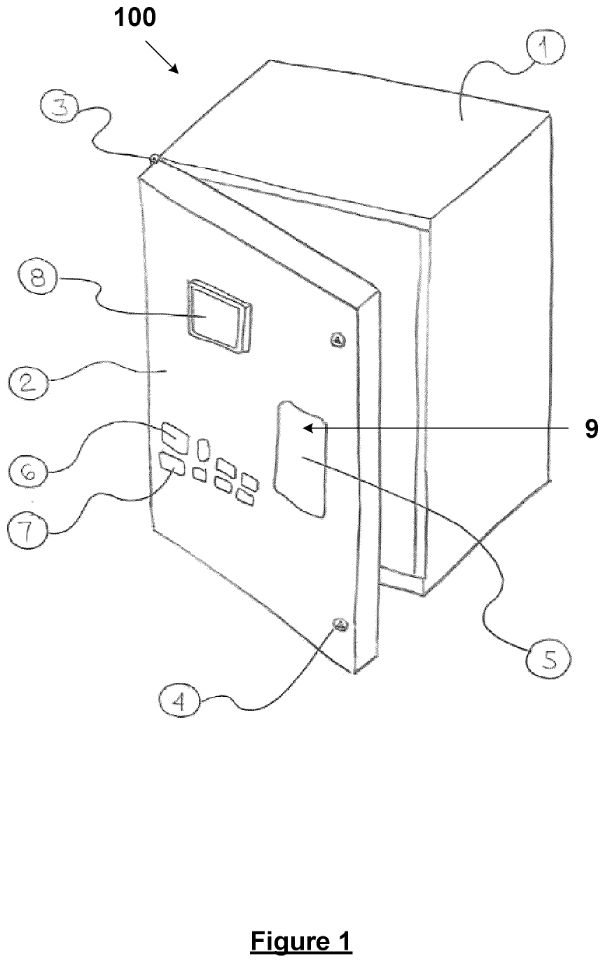

Referring now to FIG. 1, shown therein is a device 100 for refilling a container. The device 100 includes a housing 1 configured to house a refillable container (not shown). In the embodiment shown in FIG. 1, the housing 1 includes a door 2 having a hinge 3 that is configured to provide for the door 2 to open and close. When the door 2 is open, internal components of the device 100 can be accessed. These internal components are described in greater detail below. Door 2 may also include a lock 4 configured to lock the door 2 when closed.

Device 100 includes a first opening 5 that extends inwardly from a front surface of the device 100 to define a cavity 9. Cavity 9 is sized and shaped to receive the refillable container therein.

The refillable container can be any container that can be refilled with one or more products by the device 100, such as but not limited to a bulk product (e.g. a solid bulk product or a liquid bulk product). The refillable container can be reusable, can be manufactured of any suitable structural material such as metal (carbon steel or stainless steel or aluminium or other alloy), or fiberglass or plastic and can be lined or unlined. In some embodiments, a top portion of the container may be shaped to be received by at least a portion of the device 100 (e.g. a dispensing head of the device 100) to removably couple the refillable container to at least a portion of the device 100 (e.g. to minimize spilling the product upon dispensing the product into the refillable container).

Device 100 may also include a second opening 6 for receiving an empty refillable container, a third opening 7 for receiving a bottle cap, and/or a display 8 for displaying a user interface to a user of the device 100.

In some embodiments, when for example a single product is available, there can be no user detailed or sophisticated interface but rather at least one button or actuating means for filling the container.

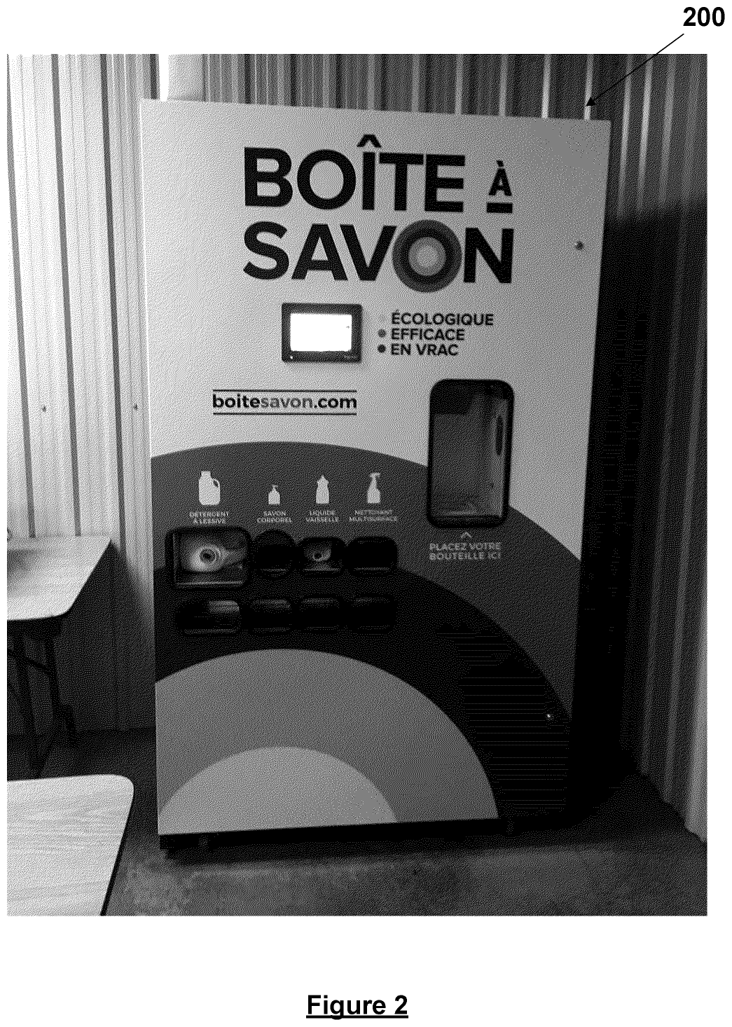

Another embodiment of a device 200 for refilling a container is shown in FIG. 2.

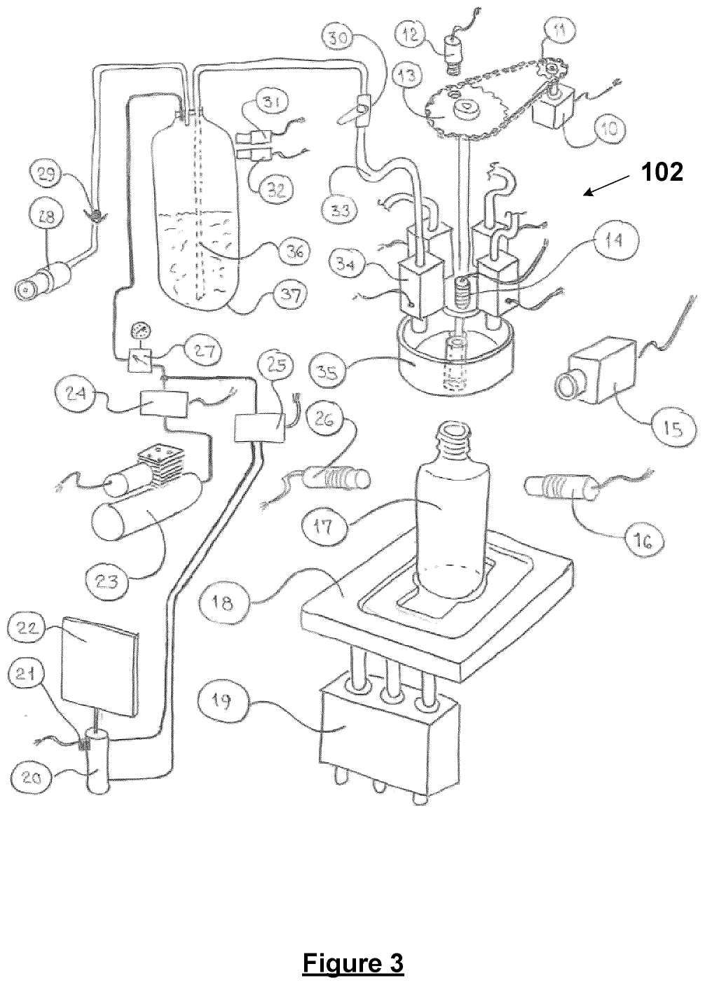

Turning to FIG. 3, shown therein is an exploded view of various internal components of the device 100 for refilling a container (e.g. container 17), according to at least one embodiment. As shown therein, the device 100 includes a dispensing head 102 configured to distribute one or more products to the refillable container. Dispensing head 102 is fluidly coupled to a supply tank 37 that retains the one or more products. Dispensing head 102 is therefore configured to receive the one or more products from the supply tank 37 and provide the one or more products to the refillable container.

As shown in FIG. 3, the dispensing head 102 includes a servo motor 10 coupled to a small sprocket 11 and a large sprocket 13 configured to rotate the dispensing head 102 upon actuation of the servo motor 10. Home position sensor 12 senses a home position of the dispensing head 102.

Dispensing head 102 may be coupled to one or more supply tanks 37 to receive the one or more products from the supply tanks 37. In the embodiment shown in FIG. 3, the dispensing head 102 includes four filling valves 34, each coupled to a hose 33 for carrying the product from the supply tank 37 to the dispensing head 102. It should be noted that the one or more products may be stored in a single supply tank (e.g. having separate compartments for each product) or in separate supply tanks 37. Herein, reference to a single supply tank 37 can be considered to include reference to both separate compartments in a single supply tank 37 and separate supply tanks 37, where appropriate. For instance, without limiting the foregoing, in at least one embodiment supply tank 37 may comprise a single product. For example at least one embodiment supply tank 37 may comprise a single vessel with a capacity in a range of about 50 to 60 litres. Further still, supply tank 37 may be housed within the housing 1 of the device 100 or, in some embodiments, supply tank 37 may be housed outside of housing 1, such as but not limited to being housed on a cart or trolley or any other mobile housing.

Between the supply tank 37 and the dispensing head 102 may be a flow valve 30 for controlling the transfer of the one or more products from the supply tank 37 to the dispensing head 102.

Supply tank 37 includes one or more sensors to detect a volume of the one or more products in the supply tank 37. For instance, in FIG. 3, the device 100 includes two sensors, a first sensor 31 and a second sensor 32. Sensors 31, 32 can be any sensors for detecting a volume of the one or more products in the supply tank 37. For instance, sensors 31, 32 can be configured to detect a height of the one or more products in the supply tank 37. In some embodiments, sensors 31, 32 can be configured to detect a volume of the one or more products in the supply tank 37, generate a signal indicating volume of the one or more products in the supply tank 37 and transmit the signal to a processor (as further described below).

Supply tank 37 may include tubing 36 for receiving aspirated product from the supply tank 37 and carrying the aspirated product from the supply tank 37 towards the dispensing head 102. Supply tank 37 also includes one or more sensors for detecting the amount of the one or more products in the supply tank 37.

To provide the one or more products to the supply tank 37, the device 100 may include a connector 28 such as but not limited to a male quick connector 28. Connector 28 may be coupled to a larger supply source (such as but not limited to a supply source provided by a distributor of the one or more products) and tubing coupled to the connector 28 may carry the one or more products from the supply source to the supply tank 37. A one way valve 29 may be positioned between the supply tank 37 and the connector 28 to control the transfer of the one or more products to the supply tank 37. In at least one embodiment, supply tank 37 may be removable from housing 1 such that supply tank 37 may be replaced when the one or more products therein needs to be refilled. Thus, supply tank can either be refilled with a product when it is empty or below a certain level or it can simply be replaced with another supply tank that is full of the desired product. Replacing of the supply tank can be made in a manner similar than an empty keg that is replaced by a keg full of a beverage in a pub.

To transfer the one or more products from the supply tank 37 to the dispensing head 102, device 100 may include an air compressor 23 fluidly coupled to the supply tank 37. Air compressor 23 may provide air to the supply tank 37 to drive product from the supply tank 37 towards the dispensing head 102. A shuttle valve 24 and/or a pressure regulator 27 may be positioned between the air compressor 23 and the supply tank 37 to monitor/control the flow of air between the air compressor 23 and the supply tanks 37.

Device 100 may also include a window gate 22, a window gate sensor 21 and a window gate cylinder 20. Device 100 may be configured such that window gate sensor 21 detects when the window gate 22 is open and/or closed and air flow between the air compressor 23 and the supply tank 37 may be controlled in response to the window gate sensor 21. Device 100 may also include a window gate valve 25.

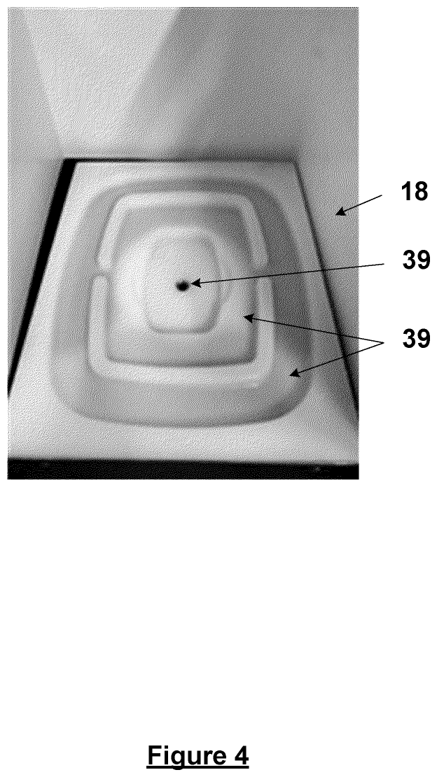

In some embodiments, device 100 includes a positioner plate 18 for supporting the container 17 in a position to receive the one or more products from the dispensing head 102. In some embodiments, the positioner plate 18 includes one or more contours corresponding to a shape of a bottom portion of the container 17 to retain the container 17 in a fixed position while the container 17 is being refilled. Positioner plate 17 may be coupled to an elevator 19 configured to vertically move the positioner plate 17 relative to the dispensing head 102 for the container 17 to receive the one or more products from the dispensing head 102. One embodiment of a positioner plate 18 having a drain 38 (to collect spilled products) and contours 39 (to retain the container 17 therein) is shown in FIG. 4.

Device 100 may include a liquid level sensor 16 for measuring the level of liquid in the container 17 as the container 17 is being refilled. In some embodiments, liquid level sensor 16 may be used to control the transfer of the one or more products into the container 17.

Device 102 may also include an imaging device 15 configured to configured to capture an image of at least a portion of the container 17 once it has been placed in the device 100 and/or on the positioner plate 18. For instance, in some embodiments, imaging device 15 may include a three-dimensional (3D) camera configured to capture an image of an outside surface of container 17 once it has been placed in the device 100. In some embodiments, imaging device 15 may be configured to scan at least a portion of the container 17. For instance, imaging device 15 may include an RFID scanner configured to scan an RFID code positioned on the container 17 or a bar code reader to scan a bar code positioned on the container 17. In some embodiments, scanner 15 may use edge detection to scan the container 17 to provide a processor (described below) with the type and/or volume of product to provide to the refillable container 17.

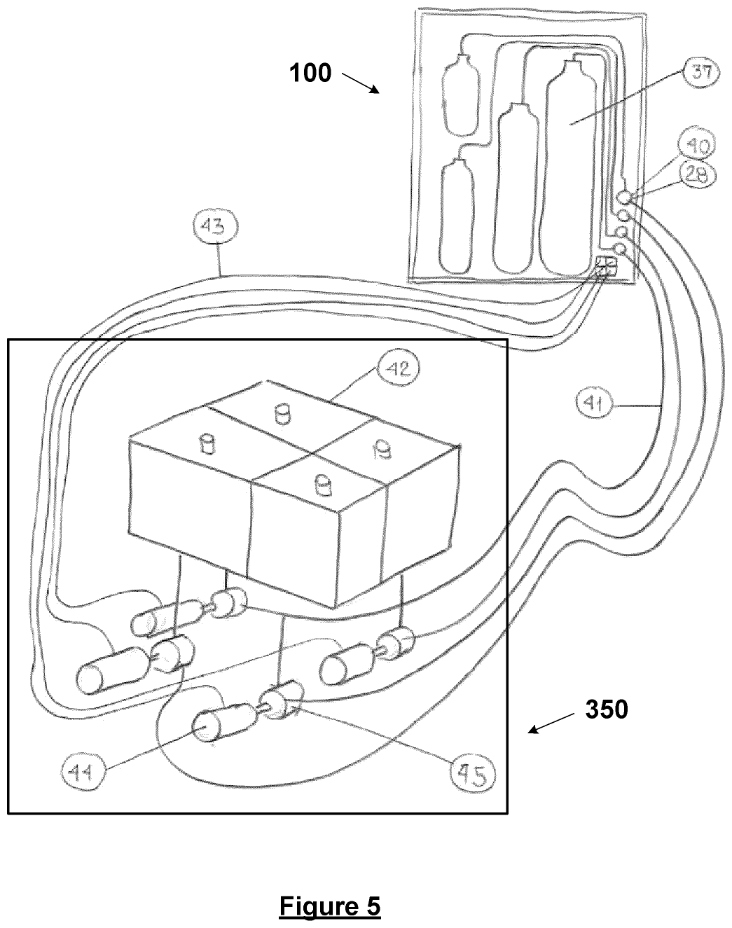

FIG. 5 is a perspective view of a filling cart 350 for filling supply tanks of a device for refilling containers with the one or more products, according to at least one embodiment. Filling cart 350 is removably coupleable to device 100 to refill supply tank 37 with one or more products via cart connector 40 that removably couples to the connector 28 of the device 100. The one or more products generally is transferred from the supply cart 350 to the device 100 via one or more flexible hoses 41. In the embodiment of filling cart 350 shown in FIG. 5, four flexible hoses 41 carry four different products from four filling cart tanks 42 of the filling cart 350 to four supply tanks 37 of the device 100. Cart electrical motors 44 and cart gear pumps 45 are shown between each filling cart tank 42 and supply tank 37 to transfer each product from the filling cart tanks 42 to the supply tanks 37.

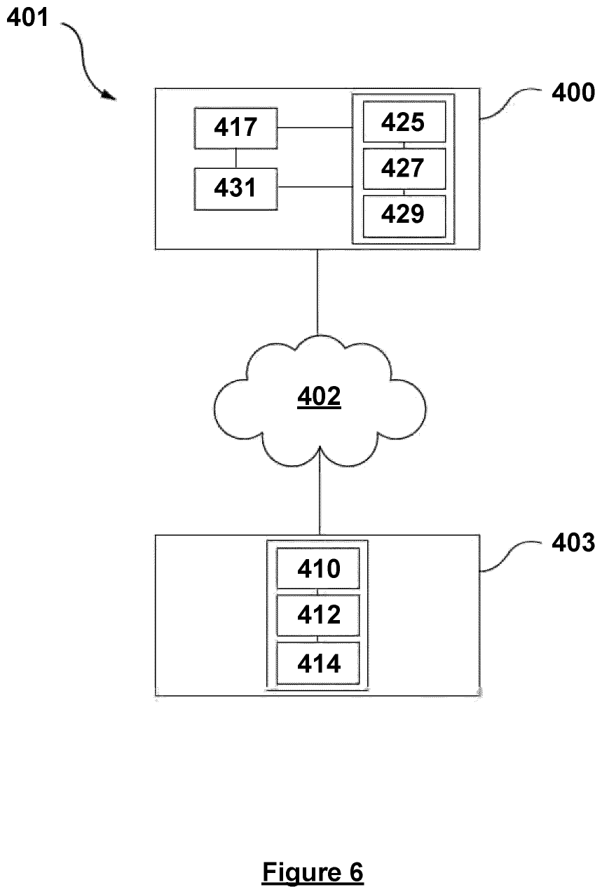

FIG. 6 is a schematic diagram of a system 401 for dispensing a product, according to at least one embodiment. System 401 includes at least one communication network 402, a distribution server 403 and a device 400 for refilling a container with the one or more products.

Distribution server 403 includes a distribution server communication interface 410, a distribution server processing unit 412 operable to communicate with the distribution server communication interface 410 and storage 414.

Distribution server processing unit 412 can control the operation of the distribution server 403. The distribution server processing unit 412 may be any suitable processing unit(s), controller(s) or digital signal processor(s) that can provide sufficient processing power depending on the configuration, purposes and requirements of the server 403. In some embodiments, the server processing unit 412 can include more than one processing unit with each processing unit being configured to perform different dedicated tasks. The distribution server processing unit 412 together with the device processing unit 427 (described below) contribute to the control of the system 401.

The distribution server communication interface 410 facilitates communication between the distribution server 403 and the other components of the system 401, such as the device 400 and other sensor units and output devices, via the communication network 402. The distribution server 403 can also connect to the Internet.

Some components of the distribution server 403 may be virtualized in a cloud computing infrastructure. A cloud computing infrastructure can improve reliability and maintenance of the distribution server 403. A cloud computing infrastructure can also allow a system 401 to manage client information and provide access control across a plurality of facilities.

Device 400 for refilling a container with the one or more products includes a supply tank 417 configured to retain the one or more products, a sensor 431 configured to detect a level of the one or more products in the supply tank 417, a device communication interface 425 operable to communicate with the distribution server 403 via the communication network 402, and a device processing unit 427 operable to communicate with at least the sensor 431 and storage 429.

Device processing unit 427 is operable to receive a signal from the sensor 431, the signal indicating the level of the one or more products in the supply tank 437; determine whether the level of the one or more products in the supply tank 437 is below a minimum threshold level, when the level of the one or more products in the supply tank 437 is below the minimum threshold level, generate a request for a distributor to distribute more of the one or more products to the device 400 and communicate the request for the distributor to distribute more of the one or more products to the device to the distribution server 403 via the communication network 402. In at least one embodiment, the communicating the request to the distribution server 403 may be by email, SMS message, text, or the like. In at least one embodiment, the generated request for the distributor can be sent directly to the distributor by email, SMS message, text, or the like.

The device communication interface 425 can include any component for facilitating communication with the other components of the system 401 via the communication network 402. For example, the device communication interface 425 can include a wireless transceiver for communicating within a wireless communications network. The device communication interface 425 can communicate identification data and/or operating data of the device 400 to the communication network 402. The device communication interface 425 can receive commands from the communication network 402.

The communication network 402 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX, Zigbee, Z-Wave, Bluetooth®, Bluetooth® Low Energy), SS7 signaling network, fixed line, local area network, wide area network, and others, including any combination of these, capable of interfacing with, and enabling communication between the distribution server 403 and the device 400.

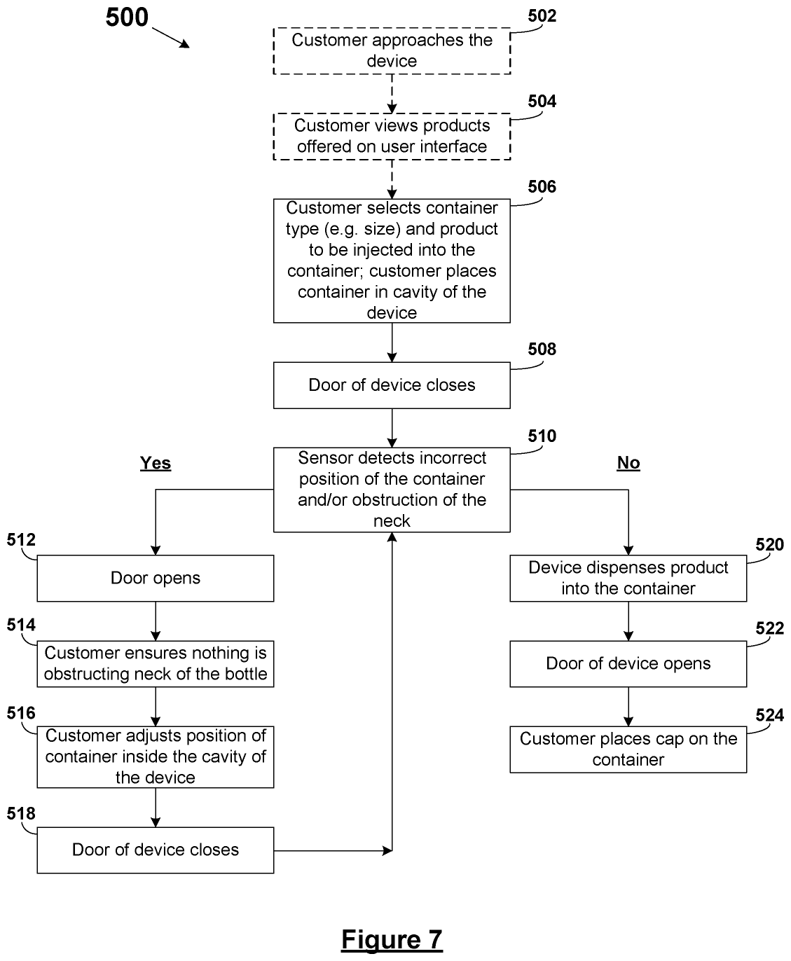

Referring now to FIG. 7, illustrated therein is a block diagram of a method 500 of dispensing a product into a container, according to one embodiment.

Method 500 may include steps 502 and 504 of, respectively, a customer approaching a device for dispensing a product into a container and the customer viewing products to be dispensed into containers on a user interface of the device.

Once the customer has decided on a product to be dispensed into the container, the customer, at step 506, selects a container type (e.g. container size and/or container shape) to receive the product to be dispensed and, optionally, the customer selects the product to be dispensed into the container. In at least one embodiment, the device may include one product to be dispensed and the customer may not have to select the product to be dispensed. The customer then places the container to receive the dispensed product into a cavity of the device. For instance, the customer may place the container on a positioner plate inside a cavity of the device.

Once the container is placed in the cavity of the device, at step 508, a door of the device closes to inhibit something from contacting the container as it is being refilled. In some embodiments, the device may include a sensor to detect when the container is positioned within the cavity and the device may automatically close the door. In other embodiments, the customer may close the door of the device.

At step 510, an imaging device of the device captures at least one image of the container, or scans at least a portion of the container and transmits the captured image or scan data to a processor of the device. The processor determines if the container is in an incorrect position within the cavity (e.g. if an opening of the container is properly aligned with a dispensing head of the device) and/or if the opening of the container is obstructed (e.g. if a cap is still on the container). By determining if the container is in an incorrect position within the cavity and/or if the opening of the container is obstructed before dispensing the product, the device may reduce the possibility that the product dispensed from the device may be wasted if either condition is true.

In the event that the container is in an incorrect position within the cavity and/or the opening of the container is obstructed, at step 512, the door of the cavity is opened (e.g. automatically or by the customer) and, at step 514, the customer can ensure nothing is obstructing the opening of the container and, at step 516, adjust the position of the container inside of the cavity of the device. At step 518, the door of the device can close (e.g. automatically or by the customer) and the method can return to step 510.

In the event that the container is in a correct position within the cavity and/or the opening of the container is not obstructed, at step 520 the device can dispense the product into the container. Afterwards, at step 522, the door of the device opens (e.g. automatically or by the customer) and, at step 524, the customer can place a cap on the container.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A system for distributing one or more products, the system comprising:
at least one communication network;
a distribution server comprising:
a distribution server communication interface; and
a distribution server processing unit operable to communicate with the distribution server communication interface; and
a device for refilling a container with the one or more products, the device comprising:
a supply tank configured to retain the one or more products;
a sensor configured to detect a level of the one or more products in the supply tank;
a device communication interface operable to communicate with the distribution server via the communication network; and
a device processing unit operable to communicate with the sensor, the device processing unit operable to:
receive a signal from the sensor, the signal indicating the level of the one or more products in the supply tank;
determine whether the level of the one or more products in the supply tank is below a minimum threshold level;
when the level of the one or more products in the supply tank is below the minimum threshold level, generate a request for a distributor to distribute more of the one or more products to the device; and
communicate the request for the distributor to distribute more of the one or more products to the device to the distribution server via the communication network.

2. The system of claim 1, wherein the sensor is positioned within the supply tank.

3. The system of claim 1, wherein the sensor is positioned adjacent to the supply tank.

4. The system of claim 1, wherein the device comprises a housing and a dispensing head to dispense the one or more products into the container, the housing comprising a positioner plate configured to support the container in a position to receive the one or more products from the dispensing head.

5. The system of claim 4, wherein a top surface of the positioner plate includes contours to conform to a bottom portion of at least one container.

6. The system of claim 4, wherein the housing further comprises a container elevator to raise and/or lower the container within the housing relative to the dispensing head.

7. The system of claim 4, wherein the housing includes an opening and an interior volume extending inwardly from the opening, the interior volume being sized to contain the container while the container is being refilled.

8. The system of claim 7, wherein the housing further comprises a door configured to cover the opening.

9. The system of claim 8 further comprising a gate sensor communicatively coupled to the supply tank and configured to detect when the door does not cover the opening, the gate sensor configured to generate a signal that inhibits transfer of the one or more products from the supply tank to the dispensing head when the door does not cover the opening.

10. The system of claim 7, wherein the device for refilling the container includes an imaging device.

11. The system of claim 10, wherein the imaging device is a three-dimensional camera positioned inside of the interior volume of the housing.

12. The system of claim 4, wherein the dispensing head is configured to receive more than one product form the supply tank and provide the more than one product to the container.

13. The system of claim 12, wherein the dispensing head is configured to receive four products form the supply tank and provide the four products to the container.

14. The system of claim 12, wherein the dispensing head is positioned above the positioner plate and is rotatable about a vertical axis extending through the positioner plate.

15. The system of claim 1, wherein the one or more products are bulk products.

16. The system of claim 1, wherein the one or more products are liquid bulk products.

17. The system of claim 1, wherein the one or more products are solid bulk products.

18. The system of claim 12, wherein the one or more products include a soap such as a liquid laundry detergent, hand soap, shampoo or all-purpose soap.

19. A method of distributing one or more products, the method comprising:
receiving a signal at a device processing unit of a device for refilling a container with one or more products from a sensor of the device, the signal indicating the level of the one or more products in a supply tank of the device;
determining whether the level of the one or more products in the supply tank is below a minimum threshold level;
when the level of the one or more products in the supply tank is below the minimum threshold level, generating a request for a distributor to distribute more of the one or more products to the device; and
communicating the request for the distributor to distribute more of the one or more products to the device to a distribution server via a communication network.

20. A device for refilling a container with the one or more products, the device comprising:
a supply tank configured to retain the one or more products;
a sensor configured to detect a level of the one or more products in the supply tank;
a device communication interface operable to communicate with a distribution server via a communication network; and
a device processing unit operable to communicate with the sensor, the device processing unit operable to:
receive a signal from the sensor, the signal indicating the level of the one or more products in the supply tank;
determine whether the level of the one or more products in the supply tank is below a minimum threshold level;
when the level of the one or more products in the supply tank is below the minimum threshold level, generate a request for a distributor to distribute more of the one or more products to the device; and
communicate the request for the distributor to distribute more of the one or more products to the device to the distribution server via the communication network.

21-34. (canceled)
